(19) United States
(12) Patent Application Publication
(10) Pub. No.: US 2012/0114875 A1
(43) Pub. Date: May 10, 2012

(54) SURFACE CONTAMINATION METROLOGY

(76) Inventor: Paul G. Dewa, Newark, NY (US)

(21) Appl. No.: 13/285,090

(22) Filed: Oct. 31, 2011

Related U.S. Application Data
(60) Provisional application No. 61/412,059, filed on Nov. 10, 2010.

(51) Int. Cl. C08J 7/18; B05D 5/06; G01N 21/64

(52) U.S. Cl. 427/553; 250/459.1; 427/162

(57) ABSTRACT

The present disclosure is directed to a method for determining the state of cleanliness of an optical component (an optic) before any coating is applied to the surface. In method is particularly applicable to optical elements and components that are intended for uses in the DUV (deep ultraviolet) and EUV (extreme ultraviolet) wavelength regions. The disclosure combines a cleaning procedure with contamination metrology utilizing a spectrometer to provide a method that will determine the state of cleanliness of the component surface by measurement of the fluorescence spectrum of the optic and comparing the measured value with a standard or reference optic of known, acceptable cleanliness. The disclosure is further directed to an optic having a selected coating thereon that is formed according to the method described herein.

### PRIORITY

This application claims the benefit of priority under 35 U.S.C. §119 of U.S. Provisional Application Ser. No. 61/412059 filed on Nov. 10, 2010 the content of which is relied upon and incorporated herein by reference in its entirety.

### FIELD

The present disclosure is directed to a method for determining the state of cleanliness of an optical component before any coating is applied to the surface. The method is particularly applicable to optical elements and components that are intended for uses in the DUV (deep ultraviolet) and EUV (extreme ultraviolet) wavelength regions.

### BACKGROUND

For optical components used in the DUV and EUV wavelength regions, and in particular, coated optical components used in DUV excimer lasers, the performance and lifetime of the component is negatively impacted by contamination in the interface between the component substrate and the thin-film coating. This contamination can arise due to the fabrication processes, storage conditions or handling of the components prior to thin-film coating. In the current state-of-the-art, while optics are processed and cleaned using best practices, nonetheless optics lifetime results have been found to vary. One currently proposed method of sorting optics for contamination is to expose coated optics to a 193 nm excimer beam and evaluate the resulting fluorescence. This method is sub-optimal because the surface has been coated before the metrology occurs. Excimer lasers are also very expensive to purchase and to operate. Although an excimer laser may pass the initial test, with time the optics are likely to fail earlier than expected if contamination remained on the surface of the optic prior to coating. Consequently, it is desirable that an alternative method of evaluating optics is desirable to be found that will greater confidence that optic lifetime will not be reduced by contamination lying between the surface of the optic and any coating applied to the optic's surface.

### SUMMARY

The present disclosure combines a cleaning procedure with contamination metrology utilizing a spectrometer to provide a method that will determine the state of cleanliness of the component surface prior to coating the component.

In accordance with the disclosure, an ultraviolet-ozone (“UVO”) cleaning process is used to clean an optic's surface prior to thin-film coating. In one embodiment the surface of the optic is cleaned by exposure, in a clean dry air (“CDA”) environment, to light emitted by a mercury-arc lamp. The short mercury-arc lamp wavelengths break the bonds of organic contaminants that may be present on the surface of the optic, and they also excite and/or break the O—O molecular oxygen bonds to form atomic oxygen which is highly reactive. The atomic oxygen thus formed, or any ozone that may be also formed, reacts with the excited/broken organic bonds to clean organic contaminants from the surface. Organic materials are those that give rise to the majority of contaminant problems in the coating process and related optic lifetime problems, the source being residual human skin oils, cleaning solvent residues, silicone oils and other organic-containing substances that have been used during preparation of the optic or placed on the optic during handling, storage, etc. Typically the organic contaminants contains C, H and O, though N and also halogens, usually F or Cl, can also be present. For example without limitation, if hydrocarbons (C and H only) are the only contaminants on the optic's surface the reaction products the excited/broken hydrocarbon bonds and the atomic oxygen, or ozone, will be CO₂, CO and H₂O, all of which are easily removable from the surface of the optic. In situations where N, F or Cl are also present in the organic materials, exemplary volatile compounds that can be formed are N₂, HCl, HF, F₂, and COF₂ in addition to CO₂, CO and H₂O.

When the optic's surface is believed to have been thoroughly cleaned, a spectroscopic metrology that can measure detect and measure fluorescence from contaminants, particularly organic contaminants, by the use of ultraviolet light is used to evaluate the optic. When the fluorescence signal matches the bulk component signal, the surface can be deemed clean. If the fluorescence signal does not match the signal of the bulk component, then the UVO cleaning step is repeated. As a result of this metrology it can be determined when an optic's surface is sufficiently clean and ready for thin-film coating.

Thus, in one embodiment, the disclosure is directed to a metrology that is a combination of a UVO cleaning method with a spectrometer to determine the state of cleanliness of the component surface, wherein the cleanliness of the surface is determined by an analysis of fluorescence from the component's (optic's) surface.

It is to be understood that both the foregoing summary and the following detailed description are exemplary of the invention and are intended to provide an overview or framework for understanding the nature and character of the invention as it is claimed in this specification. The accompanying drawings are included to provide a further understanding of the invention and are incorporated in and constitute a part of this specification. The drawings illustrate various embodiments of the invention and together with the description serve to explain the principles and operation of the invention.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 is a schematic illustrating the process flow of the present disclosure.

### DETAILED DESCRIPTION

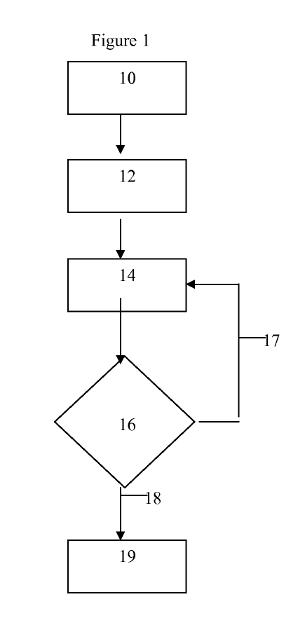

FIG. 1 is a schematic illustrating the process flow of the present disclosure. The process begins with an optic, represented by numeral 10, which has been shaped, polished, cleaned (for example without limitation, in an ultrasonic bath using a detergent containing medium and rinsing steps), and dried, and is ready for UVO cleaning The optic thus represented by numeral 10 is thus be deemed to represent the “pre-cleaned” optic 10 under this disclosure. The pre-cleaned optic 10 was then UVO cleaned as represented by numeral 12 to form what is hereafter called the “cleaned optic 12” or “optic 12”. After UVO cleaning the fluorescence spectrum of the optic 12 was measured as represented 14 and compared to the fluorescence spectrum of a known “clean” reference or standard optic or material 16 as represented by the diamond shaped box also designated by numeral 16. If the fluorescence spectrum of the optic 12 does not satisfactorily compare with that of the reference optic 16, the optic 12 is deemed “not clean” and was returned to the UVO cleaning step as represented by numeral 17. Steps 12, 14 and 16 are repeated until the optic 12 was deemed clean or was removed from the process to determine whether there is some reason why it cannot be cleaned or if there is something wrong with the measurements. If the comparison with reference optic 16 indicates that the optic 12 is clean, then as indicated by arrow 18 the optic 12 was sent to the thin-film coating process 19 to form a film coated optic.

The UVO process is, as indicated above, an oxidation process in which organic contaminants from photo resists, resins, human skin oils, cleaning solvent residues, silicone oils, and other sources are irradiated by short wavelength UV radiation so that they are dissociated or placed in an excited state where they will readily react with molecular oxygen or ozone generated by the same short wavelength UV radiation.

Atomic oxygen is generated when molecular oxygen is dissociated by 184.9 nm UV radiation and ozone is formed at 253.7 nm UV radiation. The 253.7 nm UV radiation is absorbed by most hydrocarbons and also by ozone. When both UV wavelengths are present atomic oxygen is continuously generated, ozone is continually formed and destroyed, and hydrocarbons are continuously excited and/or bonds are broken. As a result of the excitation and/or bond breaking of the contaminant hydrocarbons (or for example other hydrocarbon containing moieties such as silicones), simpler, volatile molecules are formed which desorb from the surface of the optic. Therefore, when both UV wavelengths are present atomic oxygen is continuously generated, and ozone is continually formed and destroyed. By placing properly pre-cleaned samples within eight millimeters of ozone/atomic-oxygen producing UV source, for example, the low pressure mercury vapor grid lamp in a UVO-Cleaner® (Jelight Company, Inc., Irvine, Calif.), near atomically clean surfaces can be achieved in less than one minute. In one embodiment the properly pre-cleaned optic is placed within five millimeters of the ozone/atomic-oxygen producing UV source. In another embodiment the properly pre-cleaned optic is two to four millimeters from the ozone/atomic-oxygen producing source.

Fluorescence spectrophotometers are commercially available, for example, from Horiba Scientific, Horiba Jobin Yvon, Inc., Edison N.J. or Ocean Optics, Dunedin, Fla. The coupling of the fluorescence signal from the surface to the spectrophotometer slit can be accomplished using a lens to image the surface to an optical fiber optic, and using the optical fiber to transmit the light out of the UVO box to a remote spectrophotometer. In one embodiment it has been found beneficial to place one or a plurality of notch filters in the path between the surface and spectrophotometer slit to remove the emission spectra from the UVO lamp source. When the notch filters are present the only signal reaching the spectrometer is the fluorescence signal.

It is necessary to have a standard spectrum that represents an adequately cleaned surface. This can be accomplished by carrying out repeated UVO cleaning of an optic until no changes are observed in the fluorescence spectrum of the optic.

When measurement of the optic's fluorescence signal indicates that the optic has been properly cleaned, the optic may then coated. Any coating as normally used for laser optics can be applied. These include, without limitation, hermetic coatings, mirror coatings (for reflective optics), anti-reflection coatings, partial reflector coatings (also known as beam splitters) and dichroic coatings (coatings R and Y values change with wavelength. The coating can be formed by various methods that include, for example without limitation, (1) conventional deposition (“CD”) in which materials are heated, in the presence of a substrate upon which a film is to be deposited, to the molten state by either resistance heating of electron bombardment and evaporated material from the melt condensing on the substrate; (2) ion-assisted deposition (“IAD”) which is similar to CD with the added feature that the film being deposited is bombarded with at least energetic ions of an inert gas during the deposition process (plus some ionized oxygen of the deposited film is an oxide film); (3) ion beam sputtering ((“IBS”) in which an energetic ion beams are directed to a target material and momentum transfer sputters-off target material to the substrate where it is deposited; and (4) plasma ion-assisted deposition (“PIAD”) which is similar to the IAD process except that momentum is transferred to the depositing film via a low voltage, but high current density plasma.

The metrology described herein can be used with different optical materials; for example, silica including fused silica and HPFS® silica, and doped silica; and alkaline earth metal fluorides crystalline materials such aCaF₂ and doped alkaline earth metal fluorides.

Thus, in one embodiment this disclosure is directed to a method for determining the cleanliness of an optical surface prior to the application of a coating to the surface, the method essentially consisting of (a) providing an optic that has been shaped, polished and pre-cleaned, the pre-cleaned optic 10; (b) cleaning the surface(s) of the pre-cleaned optic 10 that is to be coated with a selected coating, said cleaning being carried out using UVO cleaning for a time in the range of 1-3 minutes to provide a UVO cleaned optic 12; (c) measuring the fluorescence spectrum of the UVO cleaned optic 12 using a fluorescence spectrometer and comparing the measured fluorescence spectrum to the spectrum of a standard or reference optic 16 having an acceptable fluorescence spectrum; (d) choosing one of: (i) if the measured spectrum of optic 12 is acceptable, sending the cleaned optic 12 to be coated on the cleaned surface(s) with the selected coating, or (ii) if the measured spectrum of optic 12 is not acceptable, repeating steps (b) and (c), as indicated by numeral 17, until the measured spectrum is acceptable. In one aspect the pre-cleaned optic 10 surface(s) that is/are to be coated is/are placed within eight millimeters of the ozone/atomic-oxygen producing UV source to UVO clean the optic. In another aspect the pre-cleaned optic 10 surface(s) that is/are to be coated is/are placed within five millimeters of the ozone/atomic-oxygen producing UV source to UVO clean the optic. The fluorescence light is transmitted from the optic being measured to the fluorescence spectrometer using a lens and an optical fiber. In addition, one or a plurality of notch filters is placed between the optic whose fluorescence spectrum is being measured and the slit of the fluorescence spectrometer to thereby remove the emission spectrum of the UV light source.

In another embodiment the disclosure is directed to a method for preparing an optical component having a surface that is substantially free of organic contaminants prior to forming a selected coating on the surface of the optic, the method consisting essentially of (a) providing an optic 10 that has been shaped, polished and pre-cleaned, the pre-cleaned optic 10; (b) cleaning the surface(s) of the pre-cleaned optic 10 that is to be coated with a selected coating, said cleaning being carried out using UVO cleaning for a time in the range of 1-3 minutes to provide a UVO cleaned optic 12; (c) measuring the fluorescence spectrum of the cleaned optic 12 using a fluorescence spectrometer and comparing the measured fluorescence spectrum of optic 12 to the spectrum of a standard or reference optic 16 having an acceptable fluorescence spectrum; (d) choosing one of: (i) if the measured spectrum of optic 12 is acceptable, sending the optic 12 to be coated on the cleaned surface(s) with the selected coating, or (ii) if the measured spectrum of optic 12 is not acceptable, repeating steps (b) and (c), as indicated by numeral 17, until the measured spectrum is acceptable; and (e) coating the UVO cleaned surface of optic 12 with a selected coating to thereby provide an optic having a selected coating on UVO cleaned surface. The pre-cleaned optic 10 surface(s) to be coated is/are placed within eight millimeters of the ozone/atomic-oxygen producing UV source to UVO clean the optic, in one embodiment. In another embodiment the pre-cleaned optic 10 surface(s) to be coated is/are placed within five millimeters of the ozone/atomic-oxygen producing UV source to UVO clean the optic. In other embodiments the fluorescence light is transmitted from the optic being measured to the fluorescence spectrometer using a lens and an optical fiber, and one of a plurality of notch filters is placed between the optic whose fluorescence spectrum is being measured and the slit of the fluorescence spectrometer to thereby remove the emission spectrum of the UV light source. In a further embodiment the coating applied after UVO cleaning is selected from the group consisting of hermetic coatings, mirror coatings, anti-reflection coatings, partial reflector coatings and dichroic coatings. In addition, the disclosure is also directed to a coated optic resulting from the foregoing method.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

I claim:

1. A method for determining the cleanliness of an optical surface prior to the application of a coating to the surface, the method essentially consisting of:
(a) providing an optic that has been shaped, polished and pre-cleaned;
(b) cleaning the surface(s) of the pre-cleaned optic that is to be coated with a selected coating, said cleaning being carried out using UVO cleaning for a time in the range of 1-3 minutes to form a UVO cleaned optic ;
(c) measuring the fluorescence spectrum of the UVO cleaned optic using a fluorescence spectrometer and comparing the measured fluorescence spectrum of UVO optic to the spectrum of a standard optic 16 having an acceptable fluorescence spectrum;
(d) choosing one of:
(i) if the measured spectrum of UVO optic is acceptable, sending the UVO cleaned optic to be coated on the cleaned surface(s) with the selected coating, or
(ii) if the measured spectrum of UVO optic is not acceptable, repeating steps (b) and (c) until the measured spectrum is acceptable for application of a coating on the optic 12's surface(s).

2. The method according to claim 1, wherein the pre-cleaned optic surface(s) to be coated is/are placed within eight millimeters of the ozone/atomic-oxygen producing UV source to UVO clean the optic.

3. The method according to claim 1, wherein the pre-cleaned optic surface(s) to be coated is/are placed within five millimeters of the ozone/atomic-oxygen producing UV source to UVO clean the optic.

4. The method according to claim 1, wherein the fluorescence light is transmitted from the optic being measured to the fluorescence spectrometer using a lens and an optical fiber.

5. The method according to claim 4, wherein one of a plurality of notch filters is placed between the optic whose fluorescence spectrum is being measured and the slit of the fluorescence spectrometer to thereby remove the emission spectrum of the UV light source.

6. A method for preparing a coated optical component having a surface that is substantially free of organic contaminants prior to forming a selected coating on the surface of the optic, the method consisting essentially of:
(a) providing an optic that has been shaped, polished and pre-cleaned;
(b) cleaning the surface(s) of the pre-cleaned optic that is to be coated with a selected coating, said cleaning being carried out using UVO cleaning for a time in the range of 1-3 minutes to provide a UVO cleaned optic;
(c) measuring the fluorescence spectrum of the UVO cleaned optic using a fluorescence spectrometer and comparing the measured fluorescence spectrum to the spectrum of a reference optic having an acceptable fluorescence spectrum;
(d) choosing one of:
(i) if the measured spectrum of the UVO cleaned optic is acceptable, sending the optic to be coated on the cleaned surface(s) with the selected coating, or
(ii) if the measured spectrum of the UVO cleaned optic is not acceptable, repeating steps (b) and (c) until the measured spectrum is acceptable; and
(e) coating the UVO cleaned surface(s) with a selected coating to thereby provide an optic having a selected coating on a UVO cleaned surface

7. The method according to claim 6, wherein the pre-cleaned optic surface(s) is/are placed within eight millimeters of the ozone/atomic-oxygen producing UV source to UVO clean the optic.

8. The method according to claim 6, wherein the pre-cleaned optic 10 surface(s) is/are place within five millimeters of the ozone/atomic-oxygen producing UV source to UVO clean the optic.

9. The method according to claim 6, wherein the fluorescence light is transmitted from the optic being measured to the fluorescence spectrometer using a lens and an optical fiber.

10. The method according to claim 9, wherein one of a plurality of notch filters is placed between the optic whose fluorescence spectrum is being measured and the slit of the fluorescence spectrometer to thereby remove the emission spectrum of the UV light source.

11. The method according to claim 6, wherein the coating applied after UVO cleaning is selected from the group consisting of hermetic coatings, mirror coatings, anti-reflection coatings, partial reflector coatings and dichroic coatings.

12. An optical material formed according to method of claim 6.
